(19) United States
(12) Patent Application Publication
(10) Pub. No.: US 2013/0119202 A1
(43) Pub. Date: May 16, 2013

(54) REFUEL CONTROL SYSTEM AND METHOD OF REFUELLING

(71) Applicant: Clive Robert French, Nottingham (GB)

(72) Inventor: Clive Robert French, Nottingham (GB)

(73) Assignee: AIRBUS OPERATIONS LIMITED, Bristol (GB)

(21) Appl. No.: 13/810,991

(22) PCT Filed: Jul. 19, 2011
(86) PCT No.: PCT/GB2011/051371

§ 371 Date: Jan. 18, 2013

(30) Foreign Application Priority Data
Jul. 29, 2010 (GB) 1012735.5

(51) Int. Cl. B64F 1/28

(52) U.S. Cl. CPC B64F 1/28
USPC 244/135 A

(57) ABSTRACT

The invention provides a refuel control system for controlling refuel of at least one tank (111,112,113, 14,115,116) onanaircraft 100,the refuel control system comprising monitoring apparatus (241, 242, 280, 371, 372, 380, 311, 312, 313, 314, 315, 316, 221) for monitoring data relevant to the refuel process, a control device (330) for receiving said data from the monitoring apparatus, and a refuel valve (130) for controlling flow of fuel to the tank wherein said refuel valve is controllable by the control device such that refuel of the tank can be controlled based on the monitored data. The invention also provides a method of refuelling at least one fuel tank on an aircraft.

### BACKGROUND OF THE INVENTION

The present invention concerns a refuel control system. More particularly, but not exclusively, this invention concerns a refuel control system for controlling refuel of at least one tank on an aircraft. The invention also concerns a method of refuelling at least one tank on an aircraft.

Historically, refuel control systems were based predominantly on an interaction between a human operative and a “deadman's” switch. Whilst the human operative held down the “deadman's” switch, fuel was pumped from ground equipment into the tanks of the aircraft through a refuel coupling. Fuel level indicators in the tanks measured the level of fuel in the tanks and this information was fed to the human operative. The human operative could then release the “deadman's” switch when the tanks were full (or approaching being full) and therefore terminate the refuel process.

However, if, at the point when the refuel process should be terminated, there was a failure, refuel may continue, resulting in an overspill of fuel via the tank venting system. The failure could either be a failure in the fuel level indicator equipment or in the human operative's interpretation of the data presented to him. Such overspill of fuel presents a fire hazard and a contamination risk.

Additionally, in order for the aircraft wing structure to cope with the overspill case, the vent system is sized to cope with the maximum possible refuel pressure at the refuel coupling so the wing structure does not experience a pressure higher than the maximum pressure allowable. This means the vent system is larger and heavier than would otherwise be necessary in order to cope with this failure mode.

A procedure called “E-billing” can also be used during the refuel process. In E-billing, the amount of fuel needed is calculated based on the fuel still on board the aircraft and the fuel needed for the next flight. This calculation is often performed before the aircraft has landed. The amount of fuel needed is then inputted into the ground equipment to determine the amount of fuel delivered to the aircraft. The use of E-billing helps to automate the refuel process and minimise the chances of fuel overspill. However, there is still a risk of overspill with the E-billing system.

The present invention seeks to mitigate the above-mentioned problems. Alternatively or additionally, the present invention seeks to provide an improved refuel control system. An improved refuel control system may increase the speed of refuel, reduce the risk of overspill or make an improvement in another way.

### SUMMARY OF THE INVENTION

The present invention provides, according to a first aspect, a refuel control system for controlling refuel of at least one tank on an aircraft, the refuel control system comprising monitoring apparatus for monitoring data relevant to the refuel process, a control device for receiving said data from the monitoring apparatus, and a refuel valve for controlling flow of fuel to the tank wherein said refuel valve is controllable by the control device such that refuel of the tank is arranged to be controlled based on the monitored data.

In the context of this specification, data is used as both singular and plural. In other words, the monitored data could simply be a single piece of data (datum). The term data is used to describe any piece of information, for example, an indication of a value of a local condition (such as temperature, pressure or flow rate) or an analogue or digital signal.

The use of a control device to control the refuel valve enables the refuel process to be automated. Hence, if the monitored data indicates that the tank is approaching being full or is full, the control device will automatically control the refuel valve to close it and prevent more fuel being delivered to the tank.

Preferably, the monitoring apparatus comprises a monitoring device for monitoring local conditions data and the control device is arranged to control refuel of the tank to allow for different properties of the fuel at different local conditions in response to the local conditions data. The local conditions data may be monitored at only a limited number (for example, once or twice) during or prior to refuel.

More preferably, the monitoring apparatus comprises a monitoring device for monitoring at least one of the temperature, for example the fuel temperature, and air pressure of the tank such that the control device is arranged to control refuel of the tank to allow for expected expansion/contraction of the fuel in the tank due to a difference of temperature and/or pressure, particularly temperature, of the fuel already in the tank and the fuel yet to be delivered to the tank. For example, if the fuel being supplied to the tank by the ground equipment is at a higher temperature than the fuel already in the aircraft tank, the control device is arranged to determine the likely increase in volume of fuel in the aircraft tank due to the warmer uploaded fuel warming up the cooler fuel already in the tank. This increased volume is then subtracted from a total amount of fuel to be uploaded to the tank. The refuel valve can be arranged to be controlled accordingly to prevent the tank being overfilled.

Preferably, the control device is arranged to allow for an expected viscosity, and therefore expected flow rate, of the fuel based on the local temperature, and control opening of the refuel valve to maintain an acceptable fuel flow rate to the tank. In cooler conditions, the fuel has an increased viscosity and therefore a slower flow rate. Hence, the control device can be arranged to control the refuel valve to open more to provide an acceptable flow rate (and therefore an acceptable refuel time) at the lower temperature. In warmer conditions, the fuel has a decreased viscosity and therefore a faster flow rate (for a given delivery pressure). Hence, the control device can be arranged to control the refuel valve to close more to provide an acceptable flow rate at the higher temperatures.

As flow rate increases, so does the amount of electro-static discharge (ESD) generated by the fuel flow. Hence, the fuel flow must be controlled to maintain the ESD within acceptable levels. Therefore, the fuel flow rate can be maintained in an acceptable envelope in different climates around the world and in different seasons.

Preferably, the monitoring apparatus comprises a monitoring device for monitoring an amount of ullage expelled during refuel such that the control device is arranged to receive an indication of the remaining capacity of the tank and control refuel of the tank accordingly. This provides an indication of the amount of ullage displaced from the tank by the uploaded fuel. This gives an accurate measurement of the amount of fuel uploaded, allowing for fuel expansion in the tank. The measurements of ullage expelled can be used in combination with the measurements of fuel uploaded to allow more accurate management of the quantity of fuel uploaded.

More preferably, the ullage monitoring device is connected to a vent outlet of the tank so as to isolate the vent outlet from the atmosphere and the ullage monitoring device is arranged to monitor the amount of expelled ullage. Isolating the tank vent outlet means that the expelled ullage can be captured and Volatile Organic Compounds (VOCs) in the ullage are prevented from contaminating the local atmosphere.

Preferably, the ullage monitoring device is arranged to monitor flow rate, volume, temperature and/or pressure of the expelled ullage. This provides an independent source of data to be cross-checked against the amount, for example the volume, of fuel uploaded to the tank and the amount of ullage expelled from the tank.

Preferably, the control device is arranged to assess whether an indicated amount of fuel in the tank corresponds to the indicated amount of ullage expelled and, if not, is arranged to control the refuel valve to operate in a safe-working mode or to close. Hence, if the ullage data and the uploaded fuel data correspond, the control device functions normally. However, if the data sets do not correspond (within a safe working range), the control device can be arranged to control the refuel valve to operate in a safe working mode until the data sets correspond or can be arranged to control the refuel valve to terminate the refuel process, where the data sets do not correspond.

More preferably, the refuel control system comprises a device for capturing the expelled ullage, said capturing device being capable of being disabled such that expelled ullage is no longer captured. When the capturing device is disabled, the ullage expelled may no longer be monitored so that the indicated amount of fuel in the tank will not correspond to the indicated amount of ullage expelled. This means that if the ullage capturing device is disabled (for example, for safety reasons), the ullage data and fuel data will not correspond and the control device will then control the refuel valve to work in a safe working mode or to terminate the refuel process. This is particularly useful when refuelling the tank to maximum capacity.

Preferably, the monitoring apparatus also includes a tank level indicator, for indicating the level of fuel in the tank, and/or a flow indicator, for indicating the flow of fuel into the tank. These provide additional indications of the amount of fuel in the tank.

Preferably, the control system comprises a plurality of refuel valves, each refuel valve controlling flow of fuel into a different tank, wherein the refuel valves are separately controllable by the control device such that refuel of the different tanks is arranged to be controlled based on the monitored data. This allows the different refuel valves (and therefore refuel of the different tanks) to be controlled separately. For example, the tanks can be filled differentially based on any, or any combination, of the following: the local conditions (such as temperature/pressure) in each tank, the indicated level of fuel in each tank before refuel started, the indicated level of fuel in each tank, the fuel flow into each tank, the amount/volume of ullage expelled from the tank(s) and the pressure/temperature/rate of ullage expelled from the tank(s).

In addition, the refuel valves can be arranged to be controlled to manage refuel of the tanks to keep the ESD to within acceptable levels. ESD (electro-static discharge) is generated due to a shearing effect in the fuel as the fuel is forced through valves and through changes in flow direction. For example, different tanks have different lengths of pipeline leading to them, which affects the amount of ESD in the fuel that can “relax”. Tanks further away from the refuel coupling (distant tanks) will have a longer length of pipeline and therefore this allows the fuel to “relax” over a longer length and so the ESD in the fuel reduces. Tanks nearer the refuel coupling would be expected to have a greater amount of ESD in the fuel upon reaching the tank. Also, turbulence in the fuel generated by, for example, kinks in the pipeline also act to generate ESD. Hence, taking these factors into account, the refuel valves can be arranged to be controlled to keep the ESD in the fuel upon entering the tanks to acceptable levels by controlling the fuel flow rate to the different tanks.

In addition, the refuel valves may be arranged to be controlled to manage refuel of the tanks to minimise the refuel time. For example, the refuel valves can be controlled to be at their optimum opening setting, based on the fuel viscosity and/or temperature differential of the fuel in the tank and fuel still to be uploaded.

Preferably, one or more monitoring devices of the monitoring apparatus comprise self-test equipment, such that the self-test equipment can assess whether the monitoring device is functioning normally and indicate this to the control device, and wherein the control device can control the refuel valve(s) based on the monitored data, whilst allowing for the situation where monitored data from one or more monitored devices is likely to be incorrect if the monitoring device is deemed not to be functioning normally.

Hence, individual components of the refuel control system can be constantly monitored for identifying failures, both prior to and throughout refuel, and the refuel valve(s) can be controlled accordingly. This minimises the risk of an overspill situation.

Preferably, the monitoring apparatus is arranged to monitor the data throughout the refuel process, such that the control device is arranged to control the refuel valve(s) based on the monitored data, throughout the refuel process. This means that the refuel process and the amount of fuel delivered to the different tanks can be actively controlled throughout refuel to allow for changing data during refuel. This allows the refuel system to not have to use fixed restrictors and allow the refuel process to take place at a higher flow rate and therefore be quicker. For example, if the temperature of the tank is monitored throughout refuel, as the temperature of the tank changes, the expected expansion/contraction of the fuel will change and therefore more or less fuel will be able to be delivered to the tank.

The invention also provides an aircraft comprising a refuel control system as described above.

According to a second aspect of the invention, there is also provided a method of refuelling at least one tank on an aircraft, the method comprising the steps of providing a refuel valve for controlling flow of fuel to the tank, ascertaining data relevant to the refuel process, and controlling the refuel valve such that refuel of the tank is controlled based on the data so ascertained.

Preferably, the method includes the step of ascertaining local conditions data and the step of controlling the refuel valve to allow for different properties of the fuel at different local conditions in response to the local conditions data ascertained.

Preferably, the amount of ullage expelled during refuel is monitored, such that an indication of the remaining capacity of the tank is given to a controller, and wherein the control device controls the refuel valve and controls refuel of the tank based on that indication of the remaining capacity of the tank.

Preferably, a plurality of refuel valves are provided, each refuel valve controlling flow of fuel into a different tank, wherein a controller is arranged to separately control the refuel valves such that the controller controls refuel of the different tanks based on the ascertained data.

Preferably, the method comprises monitoring the data throughout the refuel process, and wherein the refuel valve(s) are controlled based on the monitored data, throughout the refuel process.

Preferably, the method comprises a pre-refuel step of establishing how much fuel is to be uploaded into the tank(s) based on the monitored data. This allows an estimation of the amount of fuel to be uploaded to be calculated, so the operators on the ground have an initial estimation of the amount of fuel to be uploaded before refuel starts.

Preferably, the method comprises a step of controlling the refuel valve(s) to gradually close as the indicated amount of fuel in the tank(s) reaches the desired amount of fuel. This minimizes surge pressures within the refuel pipelines and at the refuel valves.

Preferably, the method comprises the step of controlling the refuel valve(s) so as to decrease the refuel time. This allows the refuel process to be automatically controlled to optimise the refuel time. Obviously, the shorter the refuel time, the more economical it is for the airlines operating the aircraft and the airport providing the fuel.

The ullage capturing device is described and claimed in UK patent application entitled “Improvements Relating to Venting Gas from a Tank” with agent's reference “XA 3044”, having the same filing date as the present application. The contents of that application are fully incorporated herein by reference. The claims of the present application may incorporate any of the features disclosed in that patent application.

The refuel valves are described and claimed in UK patent application entitled “A Refuel Valve Assembly and Method for Refuelling an Aircraft” with agent's reference “XA 3063”, having the same filing date as the present application. The contents of that application are fully incorporated herein by reference. The claims of the present application may incorporate any of the features disclosed in that patent application.

It will of course be appreciated that features described in relation to one aspect of the present invention may be incorporated into other aspects of the present invention. For example, the method of the invention may incorporate any of the features described with reference to the apparatus of the invention and vice versa.

### DESCRIPTION OF THE DRAWINGS

Embodiments of the present invention will now be described by way of example only with reference to the accompanying schematic drawings of which:

FIG. 1 shows a schematic plan view of an aircraft being refuelled according to an embodiment of the invention; and

FIG. 2 shows a more detailed schematic plan view of an aircraft being refuelled according to an embodiment of the invention.

### DETAILED DESCRIPTION

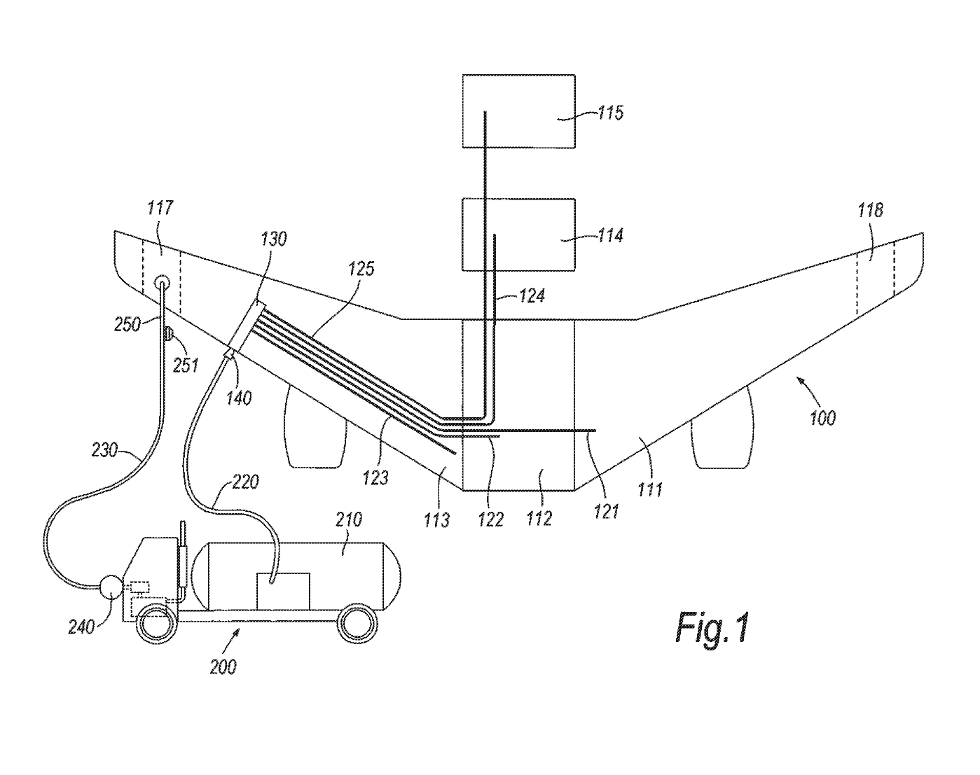

FIG. 1 shows, schematically, an aircraft 100 with a left tank 111 in the left wing (the wing on the left when viewed looking forward in the aircraft), a centre tank 112 and a right tank 113. It also has a first auxiliary tank 114 and a second auxiliary tank 115 located in the body of the aircraft. In addition, the aircraft 100 has a surge/vent tank in the outboard region of each wing. The surge tank in the left wing is labelled 118 and the surge tank in the right wing is labelled 117. The tanks, collectively, are labelled 110.

Each tank 110 has a separate refuel line 120 leading to it from a refuel coupling 140 and valve assembly 130. The refuel line to the left tank is labelled 121, the refuel line to the centre tank 122, to the right tank 123, to the first auxiliary tank 124 and to the second auxiliary tank 125.

Each refuel line 120 associated with the different tanks 110, has a valve (not shown) associated with it within the valve assembly 130. These valves control flow of fuel from the refuel coupling 140 and valve assembly 130 through the refuel line 120 to the different tanks 110.

Also shown in FIG. 1 is ground equipment, generally labelled as 200, comprising a fuel bowser 210. A fuel line 220 connects the fuel bowser 210 to the refuel coupling 140.

An ullage capture device 250 is connected to a port on the right surge tank 117 to capture ullage from the surge tank 117. The ullage capturing device 250 is connected to an ullage monitoring chamber 240 via an ullage line 230. The ullage monitoring chamber 240 is located on the bowser 210 where the ullage is then collected. The ullage capture device 250 has a valve arrangement 251 on it which prevents flow of ullage from the surge tank 117 to the bowser 210 under certain circumstances. For example, the valve arrangement 251 remains closed if there is no suction pressure from the bowser 210 or if the pressure in the surge tank 117 is considered to be too low.

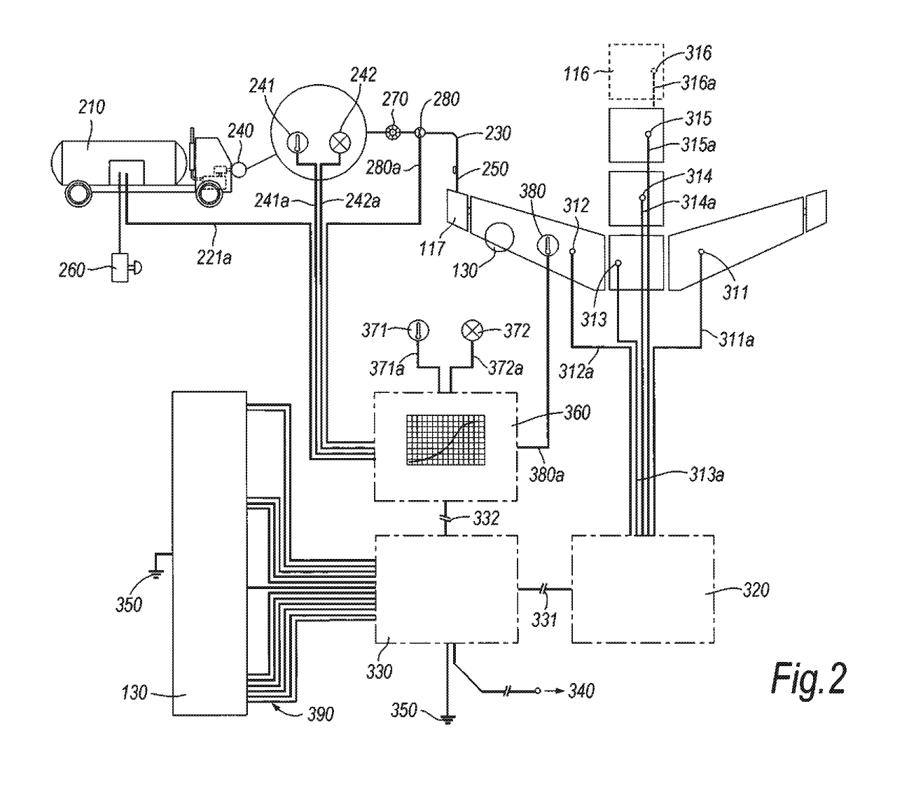

Referring now to FIG. 2, the various monitoring and control apparatus of the aircraft 100 and ground equipment 200 are shown in more detail.

In addition, it can be seen that the aircraft 100 shown in FIG. 2 comprises a third auxiliary tank 116. This third auxiliary tank 116 has a refuel line 126 (not shown) leading to the valve assembly 130.

It can be seen in FIG. 2 that each tank 110 has a level indicator 310 inside it. The level indicator 310 in each tank monitors the level of fuel in that tank and this amount can be fed to a level indicator computer 320 by tank level indicator data feed lines 310a. Left tank level indicator is labelled as 311 and the left tank level indicator data feed line as 311a. In the same manner, the right tank level indicator is labelled as 312 with the data feed line labelled as 312a. Centre tank level indicator is labelled as 313 with the data feed line 313a, first auxiliary tank level indicator is labelled as 314 with data feed line 314a, second auxiliary tank level indicator is labelled as 315 with data feed line 315a and finally third auxiliary tank level indicator is labelled as 316 with data feed line 316a.

The level indicator computer 320 is connected to a valve control computer 330 by data feed line 331. Hence, tank level information can be sent to the computer 330 for controlling the valves.

A temperature sensor 380 is located in the right wing tank of the aircraft 100 and monitors the temperature of the any fuel remaining in the tank. The temperature sensor 380 is located at the bottom of the right wing tank so it can measure the temperature of the fuel, and if there is no fuel in the tank, it will measure the air temperature in the tank. This fuel/air temperature data is fed through line 380a to a performance mapping computer 360. The performance mapping computer 360 is connected to the valve control computer 330 by a data feed line 332.

In addition, an ambient temperature sensor 371 and an ambient pressure sensor 372, which monitor the temperature and pressure of the air outside of the aircraft 100 are also connected to the performance mapping computer 360 by data feed lines 371a and 372a respectively.

The ullage line 230 is connected to an ullage flow meter 280 and a vacuum pump 270. The vacuum pump 270 acts to apply suction to pull ullage out of the surge tank 117 through the ullage capture device 250 and ullage line 230. As the ullage passes through the ullage line 230, the flow meter 280 monitors the amount of ullage flowing through the ullage line 230. This data about the amount of ullage is fed through data feed line 280a to the performance mapping computer 360.

Upon reaching the ullage monitoring chamber 240 on the fuel bowser 210, the temperature and pressure of the ullage are measured by an ullage temperature sensor 241 and ullage pressure sensor 242 in the ullage monitoring chamber 240. The temperature and pressure data of the ullage are sent to the performance mapping computer 360 by data feed lines 241a and 242a respectively.

The bowser 210 also comprises a refuel flow meter 221 (not shown). This measures the flow of fuel from the bowser to the refuel coupling 140. This information is fed through data feed line 221a to the performance mapping computer 360.

In addition, FIG. 2 shows a “deadman's switch” 260 associated with the fuel bowser 210. Fuel can only be delivered from the fuel bowser 210 to the refuel coupling 140 if this switch 260 is depressed. As soon as pressure is removed from the switch 260, refuel will shut off and no more fuel will be delivered from the fuel bowser 210 to the refuel coupling 140 until the switch is depressed again.

As described above, the valve control computer 330 has data feed line 331 from the fuel level indicator computer 320 and data feed line 332 from the performance mapping computer 360. The valve control computer 330 is also connected to ground 350 and also to the aircraft power bus 340.

The valve control computer 330 has various data feed lines 390 leading to the valve assembly 130. The valve assembly 130 is also connected to ground 350. It is important to note that FIG. 2 is a schematic drawing and in fact valve assembly 130 is located on the right wing of the aircraft 100, as shown in FIG. 1 and by a circle labelled 130 in FIG. 2.

The various data feed lines 390 from the valve control computer 330 feed to control equipment inside the valve assembly 130 in order to open and close the valves associated with the different refuel lines 120 and tanks 110. It can be seen that there are twelve lines 390 leading to the valve assembly 130 from the valve control computer 330.

One of these data feed lines 390 connects to a refuel solenoid, one line connects to a defuel solenoid, three lines each connect to a drive motor for rotating each of the left, centre and right tank valves, four lines connect to pressure transducers in the valve assembly 130 and three lines each connect to a rotary encoder for rotating each of the left, centre and right tank valves to the desired position. There are no separate data feed lines for drive motors or rotary encoders associated with the auxiliary tanks 114, 115, 116. This is because the valves controlling flow of fuel to the left 111, centre 112 and right 113 tanks are also used to control flow of fuel to the first 114, second 115 and third 116 auxiliary tanks.

Before refuel is commenced the tank level indicators 310 in the various tanks 110 indicate via the tank level indicator lines 311a, 312a etc. to the level indictor computer 320 the amount of fuel in each tank. This information is displayed on the aircraft control equipment and can be communicated to the ground equipment 200, or ground equipment crew, by the aircraft crew.

In order to commence refuel, the fuel line 220 of the refuel bowser 210 is connected to the refuel coupling 140 on the aircraft wing. The ullage capture device 250 is then connected to a port on the surge tank 117. An electrical connection between the ground equipment 200 and the aircraft 100 is also made via data feed lines 221a, 241a, 242a and 280a. In addition, electrical grounding is made between the aircraft 100 and the ground equipment 200. The compressor 270 is activated so that ullage can be pulled from surge tank 117. The valve arrangement 251 on the ullage capture device 250 is such that suction produced by the compressor 270 is only applied to the vent tank 117 when needed.

Before refuel can commence a self check process occurs. In this, the valve control and measurement apparatus on the aircraft 100 and the measurement and safety functions of the ground equipment 200 are tested. If these are considered to be working correctly, refuel can then commence.

To refuel the aircraft 100, an operator of the ground equipment 200 depresses the “deadman's switch” 260. This activates a pump (not shown) on the fuel bowser 210 to pump fuel from the bowser through the fuel line 220 and into the refuel coupling 140 and valve assembly 130. When there is refuel pressure in the valve assembly 130 from the pumped fuel, the valve assembly opens to allow the various valves in the valve assembly to selectively deliver fuel to the various tanks 110.

Throughout refuel, the ambient temperature and pressure recorded by monitoring devices 371 and 372 are fed to the performance mapping computer 360. In addition the aircraft temperature, ullage temperature and pressure, ullage flow rate and volume and refuel flow volume are also fed to the performance mapping computer 360.

Throughout refuel, the performance mapping computer 360 determines the expected viscosity of the fuel in the bowser 210 based on the ambient temperature. It also determines the difference of temperature between the ambient temperature and the aircraft temperature and uses this to calculate the expected expansion of fuel, for example due to a relatively warm fuel from ground equipment 200 mixing with cooler aircraft fuel in the tanks 110. In this way, the performance mapping computer 360 calculates the increase in fuel volume for each aircraft tank 110 due to the thermal expansion of the cold fuel already in the tank being warmed by the fuel being uplifted from the ground equipment 200. This calculation of fuel expansion is then extracted from the total volume of fuel to be uploaded that was initially indicated by the tank level indicator computer 320. This ensures that the safety limit of two percent expansion by volume can be maintained.

In addition, the performance mapping computer 360 adjusts the valve position for each tank valve such that a higher viscosity (cold) fuel will result in a larger valve opening and a low viscosity (hot) fuel will result in a smaller valve opening.

The performance mapping computer 360 constantly monitors the ambient temperature and aircraft temperature in order to signal to the valve control computer 330 of any changes.

The performance mapping computer 360 also checks the volume of ullage expelled from the tanks and compares it with the volume of fuel being refuelled through fuel line 220. If at any time during refuel, these amounts do not correspond within a safe working range, the performance mapping computer 360 will signify a malfunction to the valve control computer 330. This will initiate the valve control computer 330 either operating in a safe working mode until the levels do correspond or the valve control computer terminating the refuel process. This ensures that the risk of overspill is minimized.

In addition, the tank level indicators 310 indicate to the tank level indicator computer 320 the level of fuel in each tank throughout the refuel process. This is also inputted to the valve control computer 330 so that the opening and closing of the tank refuel valves can be based on the level of fuel indicated in each tank.

When the tank level indicators 310 (or any other indicators or a combination of indicators) show a tank to be nearing full, the corresponding valve in the valve assembly 130 is controlled by the valve control computer 330 to gradually close. For example, each valve could be closed gradually from its previous position, over a period of approximately four minutes. Ideally, the valves take longer than approximately 30 seconds to close. This reduces surge pressures in the refuel lines 120 and at the refuel valves.

Throughout refuel, the valve control computer 330 controls the opening and closing of the valves in the valve assembly 130 to control flow of fuel to each tank 110. The valve control computer 330 does this in a way to minimize refuel time whilst also keeping the electrostatic discharge (ESD) in the fuel within acceptable levels. It does this by limiting the maximum flow of fuel.

In addition, as previously described, based on information from the performance mapping computer 360 and the level tank indicators 310, the valve control computer 330 also allows for fuel viscosity, fuel expansion, the level of fuel in the tanks, the amount of fuel input through the refuel coupling and the amount of ullage expelled from the tanks.

If, at any time during refuel, the self check function of any of the components of the refuel system fails, this will be indicated to the valve control computer 330. The valve control computer 330 can then adjust refuel accordingly. For example, the data from a failed monitoring device can be effectively ignored. Alternatively, the valve control computer can be designed to shut down refuel if one of the monitoring devices is indicated as experiencing a failure.

Whilst the present invention has been described and illustrated with reference to particular embodiments, it will be appreciated by those of ordinary skill in the art that the invention lends itself to many different variations not specifically illustrated herein. By way of example only, certain possible variations will now be described.

The embodiment of FIG. 2 does not have a tank pressure sensor. As an alternative, a tank pressure sensor may also be provided. In addition, tank temperature and/or pressure sensors may be provided for individual tanks. In particular, there may be provided temperature and/or pressure sensors in the centre tank and/or auxiliary tanks. This is because these tanks experience different conditions than the right wing tank, whereas the left wing tank would be expected to experience a similar temperature/pressure as the right wing tank. For example, the centre tank is part of the fuselage of the aircraft and is shielded by the fuselage from the ambient temperature. Therefore, the tank temperature in the centre tank would be expected to rise slower than the wing tank, after landing at an airport with a high air temperature, for example. Furthermore, the fuel contained in the centre tank is normally used first in flight and is fed to both left and right wing tanks to feed the aircraft engines. Fuel in the left and right wing tanks can be warmed by unused fuel which can be returned from the engine pumps. Hence, after a long flight, a small amount of unused fuel in the centre tank may be at a lower temperature than the remaining fuel in the wing tanks. The auxiliary tanks are installed in the pressurised area of the fuselage and therefore exposed to a higher cabin air temperature and therefore would be relatively warm compared to the centre tank and wing tanks. The auxiliary tanks normally feed fuel direct to the centre tank where it is dispersed to the left and right tanks for feeding to the engines. The auxiliary tanks should be empty on landing, but a small quantity left in these tanks could be at a higher temperature than the other tanks.

As another alternative, additional and/or alternative methods of identifying the fuel level and viscosity may be provided.

As another alternative, additional auxiliary tanks may be provided. For example, up to six auxiliary tanks may be used on a single aisle aircraft.

As another alternative, the expected viscosity of the fuel in the bowser 210 is based on the temperature obtained from a temperature sensor placed within the fuel bowser and in contact with the fuel.

As another alternative, the fuel line 220 might be engaged with a refuel coupling 140 on an opposite wing of the aircraft (i.e. the left wing). Alternatively a fuel line 220 may be connected to both the right and left wings. Similarly, the ullage capturing device 250 may be provided at either or both surge tanks 117, 118 of the aircraft.

As a further alternative, a hydrant may be used instead of a fuel bowser 210.

Where in the foregoing description, integers or elements are mentioned which have known, obvious or foreseeable equivalents, then such equivalents are herein incorporated as if individually set forth. Reference should be made to the claims for determining the true scope of the present invention, which should be construed so as to encompass any such equivalents. It will also be appreciated by the reader that integers or features of the invention that are described as preferable, advantageous, convenient or the like are optional and do not limit the scope of the independent claims. Moreover, it is to be understood that such optional integers or features, whilst of possible benefit in some embodiments of the invention, may not be desirable, and may therefore be absent, in other embodiments.

1. A refuel control system for controlling refuel of at least one tank on an aircraft, the refuel control system comprising;
monitoring apparatus for monitoring data relevant to the refuel process,
a control device for receiving said data from the monitoring apparatus, and
a refuel valve for controlling flow of fuel to the tank
wherein said refuel valve is controllable by the control device such that refuel of the tank can be controlled based on the monitored data.

2. A refuel control system as claimed in claim 1, wherein the monitoring apparatus comprises a monitoring device for monitoring local conditions data and the control device is arranged to control refuel of the tank to allow for different properties of the fuel at different local conditions in response to the local conditions data.

3. A refuel control system as claimed in claim 2, wherein the monitoring apparatus comprises a monitoring device for monitoring at least one of the temperature and air pressure of the tank such that the control device is arranged to control refuel of the tank to allow for expected expansion/contraction of the fuel in the tank due to a difference of temperature and/or pressure of the fuel already in the tank and the fuel yet to be delivered to the tank.

4. A refuel control system as claimed in claim 2, wherein the control device is arranged to allow for an expected viscosity, and therefore expected flow rate, of the fuel based on the local temperature, and control opening of the refuel valve to maintain an acceptable fuel flow rate to the tank.

5. A refuel control system as claimed in claim 1, wherein the monitoring apparatus comprises a monitoring device for monitoring an amount of ullage expelled during refuel such that the control device is arranged to receive an indication of the remaining capacity of the tank and control refuel of the tank accordingly.

6. A refuel control system as claimed in claim 5, wherein the ullage monitoring device is connected to a vent outlet of the tank so as to isolate the vent outlet from the atmosphere and the ullage monitoring device can monitor the amount of expelled ullage.

7. A refuel control system as claimed in claim 5, wherein the ullage monitoring device is arranged to monitor flow rate, volume, temperature and/or pressure of the expelled ullage.

8. A refuel control system as claimed in claim 5, wherein the control device can assess whether an indicated amount of fuel in the tank corresponds to the indicated amount of ullage expelled and, if not, can control the refuel valve to operate in a safe-working mode or to close.

9. A refuel control system as claimed in claim 8, wherein the refuel control system comprises a device for capturing the expelled ullage, said capturing device being capable of being disabled such that expelled ullage is no longer captured.

10. A refuel control system as claimed in claim 1, wherein the monitoring apparatus also includes a tank level indicator, for indicating the level of fuel in the tank, or a flow indicator, for indicating the flow of fuel into the tank.

11. A refuel control system as claimed in claim 1, wherein the control system comprises a plurality of refuel valves, each refuel valve controlling flow of fuel into a different tank, wherein the refuel valves are separately controllable by the control device such that refuel of the different tanks can be controlled based on the monitored data.

12. A refuel control system as claimed in claim 1, wherein one or more monitoring devices of the monitoring apparatus comprise self-test equipment, such that the self-test equipment can assess whether the monitoring device is functioning normally and indicate this to the control device, and wherein the control device can control the refuel valve(s) based on the monitored data, whilst allowing for the situation where monitored data from one or more monitored devices is likely to be incorrect if the monitoring device is deemed not to be functioning normally.

13. A refuel control system as claimed in claim 1, wherein the monitoring apparatus is arranged to monitor the data throughout the refuel process, such that the control device is arranged to control the refuel valve(s) based on the monitored data, throughout the refuel process.

14. An aircraft comprising the refuel control system of claim 1.

15. A method of refuelling at least one tank on an aircraft, the method comprising the steps of:
providing a refuel valve for controlling flow of fuel to the tank
ascertaining data relevant to the refuel process, and
controlling the refuel valve such that refuel of the tank is controlled based on the data so ascertained.

16. The method of claim 15, wherein the method includes the step of ascertaining local conditions data and the step of controlling the refuel valve to allow for different properties of the fuel at different local conditions in response to the local conditions data ascertained.

17. The method of claim 15, wherein the amount of ullage expelled during refuel is monitored, such that an indication of the remaining capacity of the tank is given to a controller, and wherein the control device controls the refuel valve and controls refuel of the tank based on that indication of the remaining capacity of the tank.

18. The method of claim 15, wherein a plurality of refuel valves are provided, each refuel valve controlling flow of fuel into a different tank, wherein a controller is arranged to separately control the refuel valves such that the controller controls refuel of the different tanks based on the ascertained data.

19. The method of claim 15, wherein the method comprises monitoring the data throughout the refuel process, and wherein the refuel valve(s) are controlled based on the monitored data, throughout the refuel process.

20. The method of any claim 15, wherein the method comprises a pre-refuel step of establishing how much fuel is to be uploaded into the tank(s) based on the monitored data.

21. The method of claim 15, wherein the method comprises a step of controlling the refuel valve(s) to gradually close as the indicated amount of fuel in the tank(s) reaches the desired amount of fuel.

22. The method of claim 15, wherein the method comprises the step of controlling the refuel valve(s) so as to decrease the refuel time.
